(19) United States
(12) Patent Application Publication
(10) Pub. No.: US 2026/0200381 A1
(43) Pub. Date: Jul. 16, 2026

(54) IMPACT SHIELD FOR A CHILD SEAT

(71) Applicant: CYBEX GmbH, Bayreuth (DE)

(72) Inventor: Stoil BOZHIKOV, Bayreuth (DE)

(21) Appl. No.: 19/137,271

(22) PCT Filed: Dec. 6, 2023
(86) PCT No.: PCT/EP2023/084527

§ 371 Date: Jun. 9, 2025

(30) Foreign Application Priority Data
Dec. 13, 2022 (DE) 20 2022 106 949.2

(51) Int. Cl. B60N 2/427

(52) U.S. Cl. CPC B60N 2/42709

(57) ABSTRACT

Impact shield (100) for a child seat (10), wherein the impact shield (100) comprises:
a restraint portion (105),
a first connection part (110) and a second connection part (120), which are each transferable, in particular displaceable, at least in sections relative to the restraint portion (105) from at least a first position into at least a second position, and
an adjustment mechanism for adjusting the respective position of the first and second connection parts (110, 120), wherein the adjustment mechanism comprises an operative connection which connects the first and second connection parts (110,120) to one another and causes that the adjustment of one of the first connection part (110) and the second connection part (120) causes a corresponding adjustment of the other of the first connection part (110) and the second connection part (120).

The invention relates to an impact shield for a child seat for installation in a vehicle seat, as well as a corresponding child-accommodation device, in particular a child seat, and a method for adjusting a child seat or impact shield.

A child seat with an impact shield is known, for example, from DE 10 2012 100 707 A1. Such impact shields are intended to hold a child sitting in a child seat in the seat, in particular in the event of an accident or heavy braking. Such impact shields can be fixed to the child seat itself. In DE 10 2012 100 707A1, the fastening of the impact shield is achieved by means of corresponding belt sections.

Furthermore, solutions are known, for example from DE 10 2022 100 184A1, in which there is an essentially rigid fastening structure which fastens the impact shield to both sides of the child seat, wherein sections of the fastening structure are displaceable for adjusting the impact shield (with regard to a size of the child).

Overall, the solutions in the prior art are considered to be in need of improvement with regard to adjustment of the impact shield (in particular with regard to the size of the child).

The object of the invention is to propose an impact shield for a child seat (for attachment to a motor vehicle seat) which can be adjusted comparatively precisely and at the same time in a simple manner (with regard to the size of a child). Furthermore, the object of the invention is to propose a corresponding child-accommodation device, in particular a child seat, as well as a corresponding method for adjusting a child seat or impact shield.

This object is achieved in particular by the features of claim 1.

In particular, the object is achieved according to a first independent aspect by an impact shield for a child seat (for attachment to a motor vehicle seat), wherein the impact shield comprises:
a restraint portion (for restraining the child, in particular in the event of an accident or braking),
a first connection part and a second connection part, which are each transferable, in particular displaceable, at least in sections (if necessary only in sections), relative to the restraint portion from at least a first position to at least a second position, and
an adjustment mechanism for adjusting the respective position of the first and second connection parts, wherein the adjustment mechanism comprises an operative connection which connects the first and second connection parts to one another and causes that the adjustment of one of the first connection part and the second connection part causes a corresponding adjustment of the other of the first connection part and the second connection part (and preferably vice versa, such that the adjustment of the other of the first connection part and the second connection part causes a corresponding adjustment of the one of the first connection part and the second connection part).

One idea behind the first aspect lies therein, by means of the operative connection, to enable a functional link, in particular a synchronisation, between the adjustment of the first and second connection parts, in particular in such a way that a load on, for example, the first connection part (e. g, by a lateral loading of the restraint portion close to the first connection part) via the operative connection causes that the second connection part is also loaded accordingly, By this can in particular be achieved that the restraint portion can be uniformly adjusted (for example to adapt it or the impact shield as a whole to the size of the child).

In principle, it is to be observed, for example with regard to DE 10 2022 100 184A1, that in solutions in the prior art with rigid connection structures, the connection structures cannot always be adjusted (completely) independently of each other. However, due to the lack of an operative connection there, a unilateral load on the impact shield (for example a unilateral pulling on the impact shield to widen a space between impact shield and main body of the child seat for the child) leads to tilting, which ultimately makes adjustment altogether more difficult or does not allow an adjustment in the event of a unilateral load.

Under an operative connection is to be understood in particular a connection (between first and second connection part) which transfers a positional change from one of the two connection parts to the other of the two connection parts, in particular in such a way that the other connection part is also adjusted (correspondingly). The operative connection is preferably provided in addition to the restraint portion (or a main body thereof) and is partially or completely movable relative thereto (in particular displaceable and/or rotatable, for example partially displaceable and partially rotatable). In particular, an operative connection should not already exist if two connecting structures are each connected to the restraint portion (or a main body thereof) and are thus connected to each other (if applicable) via the restraint portion (or its main body).

According to a second aspect (independent, preferably combinable with the first aspect), an impact shield for a child seat is proposed, wherein the impact shield comprises:
a restraint portion with a central portion as well as right and left end portions, a first connection part and a second connection part, which are each transferable, in particular displaceable, at least in sections, relative to the restraint portion from at least a first position into at least a second position, and
a fixing mechanism which is configured to selectively fix, in particular completely, or not to fix, the first connection part and the second connection part relative to the restraint portion, wherein the fixing mechanism comprises a, in particular a form-fitting, fixing device, preferably a latch and an engagement, wherein the fixing device is provided at least in sections on the central portion of the restraint portion, in particular in the centre of the restraint portion.

One idea of the second aspect is to provide a fixing device on the central portion of the restraint portion. By this a reliable fixing (fixation) of the first or the second connection part can be carried out in a simple manner, which improves usability and thus also safety.

In principle, the restraint portion can have a central portion as well as a right and a left end portion.

A centre of the restraint portion is preferably understood to mean an area of the restraint portion which is in each case at least 20%, preferably at least 30% or at least 40% of a left-right extension of the restraint portion away from the two outermost points (left and right) of the restraint portion. When ‘left’ or ‘right’ is mentioned here and below, reference is made in particular to the state, which the impact shield assumes, when it is (correctly) attached to the child seat.

According to a third aspect (which is preferably combinable with the first and/or second aspect), an impact shield for a child seat (for attachment to a motor vehicle) is proposed, wherein the impact shield comprises:
a restraint portion and
a first connection part and a second connection part, which are each transferable, in particular displaceable, at least in sections, relative to the restraint portion from at least a first position into at least a second position, wherein the first connection part and/or the second connection part, according to a first sub-aspect of the third aspect, comprise at least one flexible, shear-resistant means, in particular at least one wire portion and/or at least one rope portion and/or at least one ribbon portion. Preferably, the impact shield further comprises a fixing mechanism which is configured to selectively fix, in particular completely, or not fix the first connection part and the second connection part relative to the restraint portion.

Alternatively or in addition to the first sub-aspect, according to a second sub-aspect of the third aspect, the first connection part and/or the second connection part may have at least one holder for at least one electrical line.

One idea of the first sub-aspect is to provide a first or second connection part which, on the one hand, is flexible (i.e. in particular can change its shape, preferably curvature), but on the other hand is shear-resistant in the sense that that, when the restraint portion moves in the direction of a main body of the child seat (or in the direction of the properly accommodated child), it resists deformation, i.e. in particular does not buckle or fold (such as a fabric belt). In this respect, a portion of a fabric belt and/or a cord should not be understood as a shear-resistant means.

Preferably, the respective connection part (or the flexible, shear-resistant means) can change its shape (in use, in particular during transfer), but is dimensionally stable in the sense that it assumes a predetermined shape without the application of an external force (again unlike, for example, a fabric belt or the like). Overall, the first sub-aspect makes it possible to achieve a simple and reliable adjustment of the impact shield, in particular a simple and reliable reduction (by pushing or pressing) of a distance between the impact shield and the main body of the child seat.

One idea of the second sub-aspect is that the first or second connection part has a holder (holding device) for at least one electrical line (for transmitting an electrical signal and/or an electrical current, for example for the power supply). In the second sub-aspect, in particular, the at least one corresponding electrical line may also already be provided (e.g. at least one cable comprising, e.g., at least one electrical conductor and an enveloping insulation). The holder is preferably configured to enclose the electrical line at least in sections and may, for example, comprise a channel. By this an electrical supply to the impact shield (for example to activate or trigger an airbag) can be carried out in a simple and reliable manner, which increases safety.

The main body mentioned above may be a seat for the child (seat element, possibly comprising a seat portion and optionally a backrest), Insofar as the child seat has an impact shield, this should not be conceptually assigned to the main body,

The child seat, in particular the main body thereof, may have a seat portion which is configured to rest with an underside on a vehicle seat portion and/or a base.

Preferably, the child seat, in particular its main body, also has a backrest. The child seat, in particular its main body, may have further elements, such as one or several side wings, a headrest, a support foot and/or a base.

The impact shield may comprise a restraint portion as well as a first and a second connection part. The restraint portion is preferably configured to catch the child. The restraint portion preferably extends over at least 20 cm, more preferably at least 30 cm in a left-right direction. The restraint portion may comprise padding and/or a fabric cover. Furthermore, the restraint portion may optionally comprise an airbag.

The restraint portion preferably forms a main body of the impact shield, which in turn preferably defines at least 60% by weight, more preferably at least 80% by weight, of the entire impact shield.

The restraint portion may have a central portion as well as a right and left end portion. The left and right end portions are preferably connected to each other by the central portion. The left and right end portions may extend in the direction of the main body of the child seat (i.e. have a main direction of extension pointing in the direction of the main body of the child seat). A main direction of extension in particular means a direction in which the respective element or the respective portion mainly extends. In a rectangular structure, this would be, for example, the direction in which the two longer sides of the rectangle run. The central portion may extend (at least essentially) in a left-right direction (with respect to its main direction of extension).

The central portion may be configured so that, in a use configuration of the child seat, it defines a first gap between the impact shield and a seat surface (or seat portion) of the main body of the child seat. If the main body of the child seat comprises a backrest, a second gap is preferably formed between the central portion and the backrest (in a use configuration of the child seat),

The first gap (and, if present, the second gap) is preferably dimensioned such that the child can be accommodated in the child seat with the child's thighs extending at least partially through the first gap and the child's abdomen and/or the child's chest preferably extending at least partially through the second gap.

Central portion and end portion can together form a U-shape (in cross-section), whereby preferably (in a use configuration) the U is open towards the child or main body of the child seat.

A connection part is preferably understood to mean a structure which is configured to fasten the restraint portion to the main body of the child seat. The respective connection part (beyond this fastening effect) preferably has no further—at least essentially no further—function for holding the child (directly), such as in particular the restraint portion.

A transfer from a first position into a second position (at least of a portion of the respective connection part) is understood in particular to mean a corresponding relocation relative to the restraint portion. This relocation may comprise a displacement and/or a rotation. The relocation may also take place partially or completely by a shape change (for example, by a change of the curvature). However, a (partial) displacement of the respective connection part is particularly preferred, whereby the displacement according to embodiment can be set by a corresponding guide (in particular a guide rail).

As adjustment mechanism for adjusting the respective position, preferably a (possibly multi-part, whereby the individual parts can either be connected to each other or at least partially not connected to each other) mechanism is to be understood which makes it possible to change the impact shield or, in particular, its restraint portion in relation to a distance of the impact shield or restraint portion from the main body of the child seat (and thus space for the child).

In general, the impact shield (in particular the restraint portion) can be moved towards the main body (to adjust the impact shield for smaller children) and away from the main body of the child seat (to adjust the impact shield for larger children).

Preferably, the impact shield or its restraint portion can be moved into at least two or at least three or at least five different settings. The different settings may be discrete settings or a continuum of settings.

A fixing mechanism is preferably understood to mean a mechanism which fixes the respective connection part in relation to the restraint portion, in particular so that a positional change of the connection part is not possible.

The first connection part and/or the second connection part may comprise at least one flexible and/or shear-resistant means, in particular at least one wire portion or at least one rope portion or at least one wall section. In particular, in the first and second aspects and the second sub-aspect of the third aspect, the first and/or second connection part can also be formed by a (non-form-stable) belt or belt portion,

Possibly also independently of the further features of the third aspect (for example, in the first and/or second aspect and/or the first sub-aspect of the third aspect), the first connection part and/or the second connection part may have at least one holder for at least one electrical line, preferably comprising the electrical line itself. In this regard, reference is made to the corresponding explanations for the second sub-aspect of the third aspect.

The first connection part and/or the second connection part may comprise at least one means which deforms during the respective transfer, preferably changing its curvature at least in sections, wherein the means preferably corresponds to the shear-resistant means according to the first sub-aspect of the third aspect and/or corresponds to the flexible and/or shear-resistant means as mentioned above.

A (pure) displacement of a first portion of the respective connection part relative to a second portion of the connection part (for example, in telescope-like solutions) is preferably not to be understood as deformation. A deformation preferably implies a change in the curvature and/or a (material) elongation and/or a (material) compression. The deformation is preferably elastic, so that the original shape is taken again (in particular upon discontinuation of external forces acting on the respective connection part). Preferably, the connection parts move in the respective (in particular synchronous) transfer at least in sections (where ‘in sections’ preferably relates to end portions that are closer to the restraint portion) in different directions. The different directions can, for example, form an angle of at least 90°, possibly at least 120° or (at least approximately) 180°.

Alternatively or additionally, the first and/or second connection part moves during the respective transfer at least in sections (where ‘in sections’ preferably relates to end portions that are closer to the restraint portion) in a direction which deviates from a direction of movement (during the displacement of the restraint portion for adjusting the impact shield) by less than 180° (possibly less than 150° or less than 120°, for example at least essentially 90°) and/or more than 0°, preferably more than 30° or more than 60°.

In embodiments, the operative connection comprises at least one gear. In particular, the gear is configured to change at least one variable of motion, e.g. force and/or torque. In some cases, the change in a force or torque plays the decisive role. With regard to the gear, for example, the first connection part can form the drive and the second connection part the output-and/or vice versa.

The gear may be a mechanical and/or hydraulic gear. The gear may be configured to convert at least one torque and/or at least one direction of rotation and/or at least one rotational speed and/or at least one force, in particular at least one direction of a force and/or an amount of a force.

The operative connection (in particular the gear) may comprise at least one toothing, preferably at least one gear wheel and/or at least one row of teeth.

The first and/or second connection parts may have a toothing, in particular a row of teeth, which (in each case) can preferably be brought into engagement with a gear wheel (in particular of the gear). The axis of rotation of the gear wheel is preferably locally fixed relative to the restraint portion.

The gear wheel can be located between the row of teeth of the one connection part and the row of teeth of the other connection part. When the row of teeth of the one connection part is moved relative to the gear wheel, it can cause the gear wheel to rotate, whereby this rotation in turn preferably causes a movement of the row of teeth of the other connection part. When reference is made here (above and below) to a movement of the respective connection part, this should be understood in particular (unless otherwise specified) to mean a movement in sections of the respective connection part relative to the restraint portion. The respective movement is preferably (without further specification) a translational movement or at least comprises such a movement.

The first connection part can be configured to be connected to the child seat in a manner that cannot be released or can only be released using tools. Alternatively or additionally, the second connection part may be configured to be connected manually (preferably releasably) to the child seat, for example via a belt tongue-belt buckle pair. In particular, the second connection part may have a belt tongue which can correspondingly be inserted into a belt buckle of the main body of the child seat.

Preferably, a fixing mechanism (in particular the fixing mechanism according to the second or optional third aspect) is provided. The fixing mechanism is preferably configured to selectively fix, in particular completely, or not fix the first connection part and/or the second connection part relative to the restraint portion.

The fixing mechanism may, according to embodiment, form a structural unit and/or have a common latching device for jointly locking the first and second connection parts. The common latching device may preferably have a common latch and/or a common clearance which can be brought into engagement with both the first as well as the second connection part at the same time. Alternatively or additionally, the common latching device may have a latch and/or a clearance which can only be brought into engagement with one of the first and/or second connection part for fixing it, wherein a fixing of the other of the first and second connection part (e.g. by the operative connection) can be realised. For example, the common latching device can lock the first connection part directly, thereby also indirectly locking the second connection part (e.g. due to the operative connection).

In embodiments, the impact shield can have an airbag.

The object is further solved in particular by a child seat for mounting in a motor vehicle seat, comprising an impact shield as described above (and below).

The object is further solved in particular by a child-accommodation device, in particular a child seat (preferably for a motor vehicle seat), preferably as described above, in particular comprising an impact shield, preferably as described above, and/or an Isofix anchoring structure, wherein the child seat comprises:
a first connection part and a second connection part, which are each transferable, in particular displaceable, at least in sections, relative to the restraint portion from at least a first position into at least a second position, and
an adjustment mechanism for adjusting the respective position of the first and second connection parts, wherein the adjustment mechanism comprises an operative connection which causes that the adjustment of one of the first connection part and the second connection part causes a corresponding adjustment of the other of the first connection part and the second connection part.

The above-mentioned object is further solved by a method for adjusting a child seat, preferably as described above, and/or an impact shield, preferably as described above, for a child seat (preferably for mounting on a motor vehicle seat), wherein a first connection part and a second connection part are each transferred at least in sections relative to a main body of the child seat or the impact shield from at least a first position into at least a second position, wherein an adjustment of the position of one of the first and second connection parts causes a corresponding adjustment of the other of the first and second connection parts.

The above-mentioned object is further solved in particular by a method, preferably as described above, for adjusting a child seat, in particular as described above, or an impact shield, in particular as described above, wherein a first connection part and a second connection part are each transferred at least in sections relative to a restraint portion of the impact shield from at least a first position to at least a second position, wherein the first connection part and the second connection part are fixed relative to the main body by a common action taking place centrally.

Further features of the method are apparent from the above and following description of devices, wherein corresponding functional features can be carried out as specific method steps. For example, if an electrical conductor is present, a method step of conducting an electrical current can be carried out, e.g. for signal transmission and/or energy supply, e.g. to an airbag.

The first connection part and the second connection part are preferably guided on the restraint portion.

Further embodiments are apparent from the dependent claims.

The invention is explained below with reference to the figures, also with regard to further features and advantages. Herein are shown:

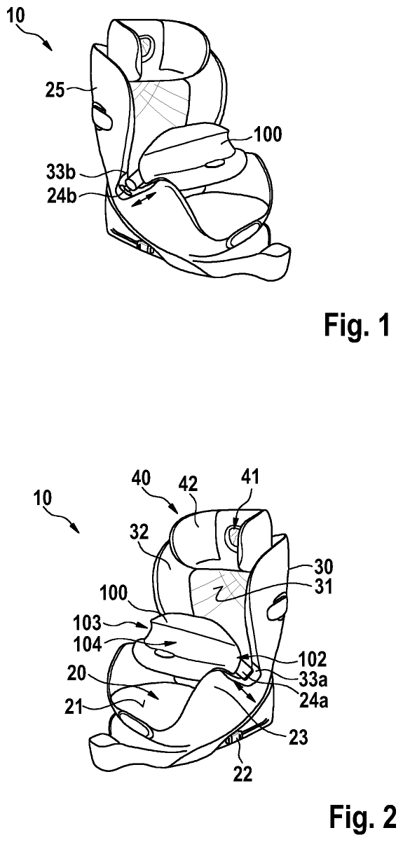

FIG. 1 an oblique view of a child seat according to the invention;

FIG. 2 another oblique view of the child seat according to FIG. 1;

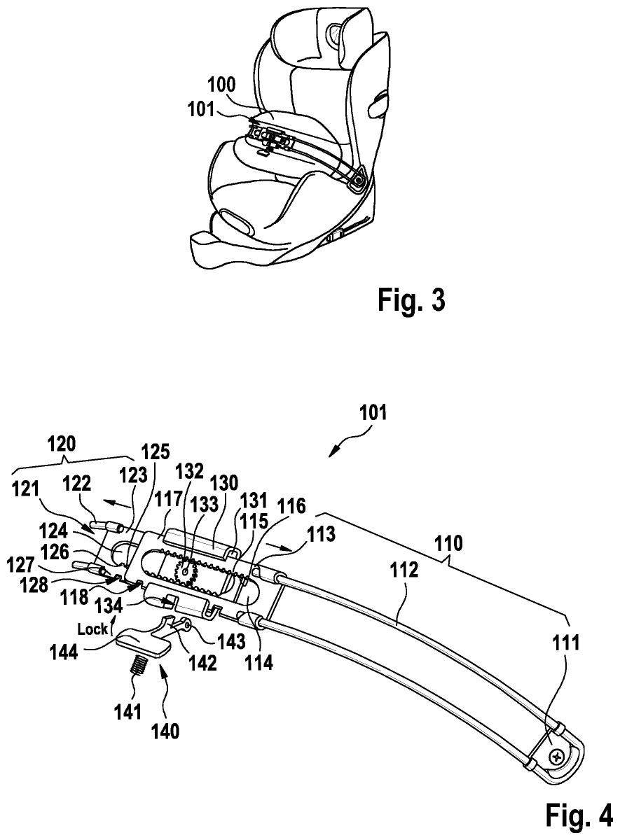

FIG. 3 another oblique view analogous to FIG. 2 with the interior partially exposed;

FIG. 4 parts of the impact shield of the child seat according to FIGS. 1-3 in an oblique view;

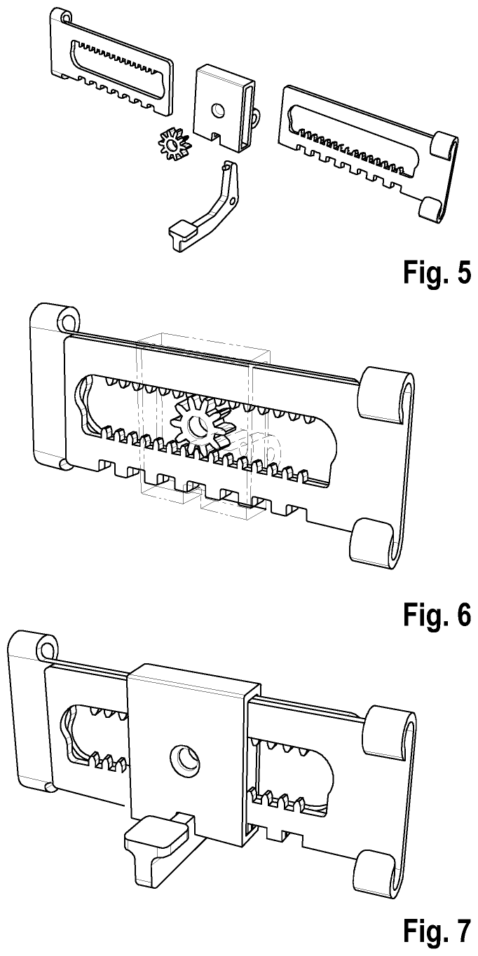

FIG. 5 parts of the impact shield of the child seat according to FIGS. 1-3 in an exploded view;

FIG. 6 parts of the impact shield of the child seat according to FIGS. 1-3, partially drawn transparently;

FIG. 7 parts of the impact shield of the child seat according to FIGS. 1-3 in an oblique view;

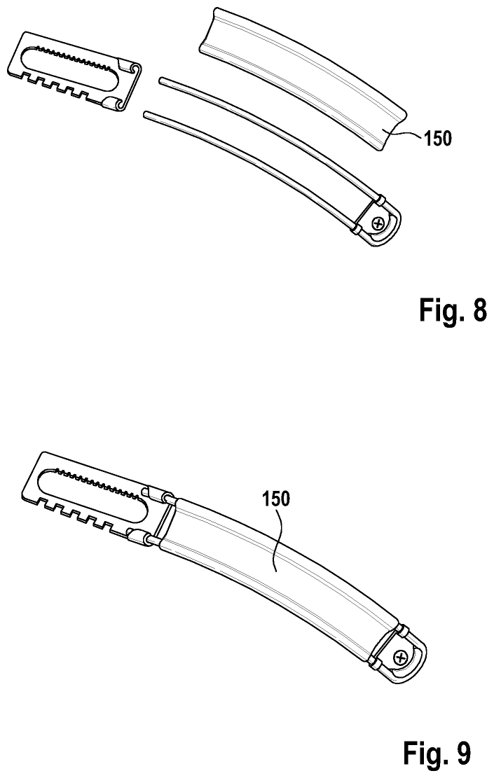

FIG. 8 parts of the impact shield of the child seat according to FIGS. 1-3 in an exploded view;

FIG. 9 the parts according to FIG. 8 in assembled state;

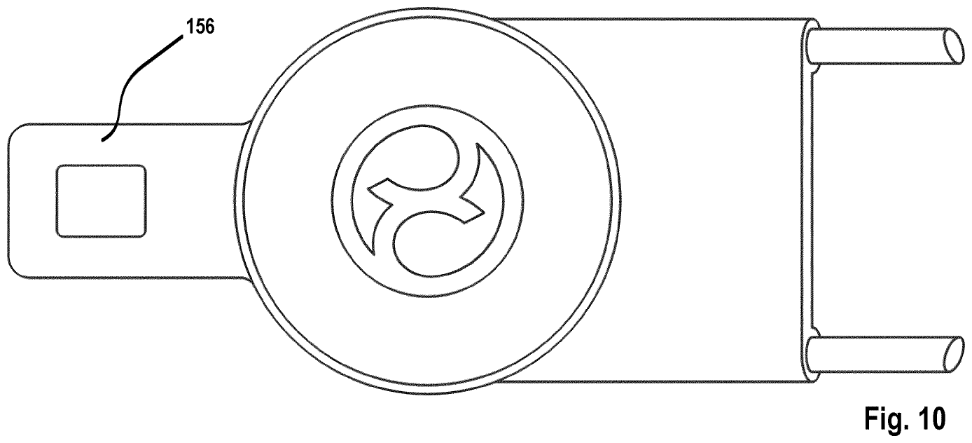

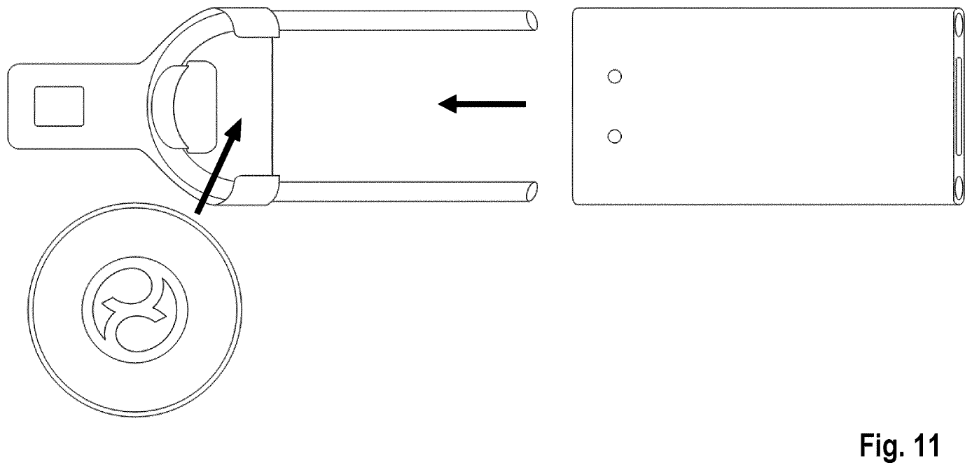

FIG. 10 a section of the impact shield of the child seat according to FIGS. 1-3;

FIG. 11 a section of the impact shield of the child seat according to FIGS. 1-3 in an exploded view;

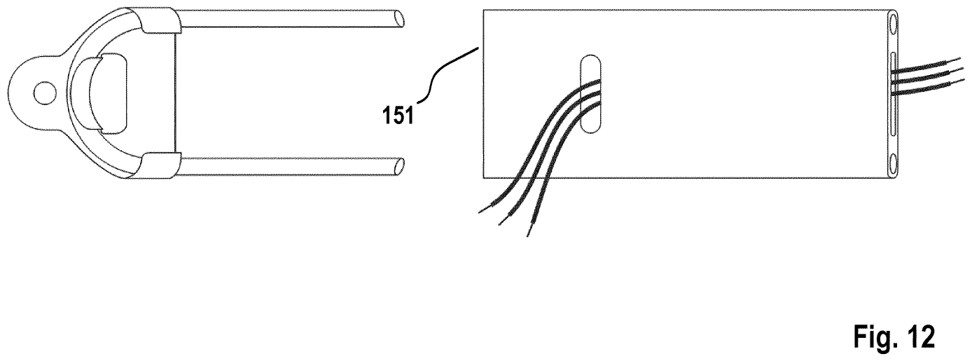

FIG. 12 a further section of the impact shield of the child seat according to FIGS. 1-3 in an exploded view;

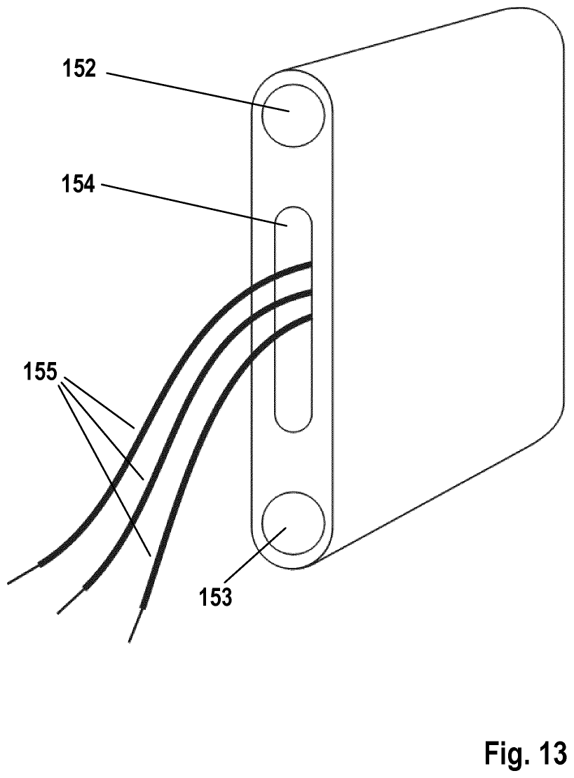

FIG. 13 parts of the impact shield of the child seat according to FIGS. 1-3 in an oblique view.

In the following description, the same reference numbers are used for identical and similarly functioning parts.

FIGS. 1 and 2 show a child seat 10. The child seat 10, in particular a main body (seat element, which can preferably define a seat) 25 thereof, preferably comprises a headrest 40 with a headrest surface 41, a seat area 20 with a seat surface 21, as well as a backrest 30 with a backrest surface 31.

The seat area 20 may comprise fastening means (e.g. comprising one or two Isofix hooks) for fastening the child seat 10 to a vehicle seat. An optional side element 23 is provided on each of the side areas of the seat area 20. Side bolsters 32 are preferably formed on the backrest 30.

Side receptacles 33a and 33b may be formed between the seat area 20 and the backrest 30, in particular between the side elements 23 and the side bolsters 32, in which an impact shield 100 can be at least partially received so that the impact shield 100 is incorporated into the seat geometry, in particular is at least partially received in a form-fitting manner. Overall, an impact shield seat is provided in accordance with the embodiment.

The impact shield 100 is connected to the main body 25 of the child seat 10, in particular to the side receptacles 33a and 33b, in particular to an area of the side bolsters 32 and side elements 23, via fastening means 24a, 24b. The main body 25 is in particular understood to be that part of the child seat which provides the actual seat. The main body may therefore be a complete seat (in particular comprising a backrest) (apart from the safety or restraint device in the form of the impact shield).

The impact shield 100 is preferably releasably connected to the main body 25 on at least one side (possibly only on one side or on both sides), In one embodiment, the impact shield 100 can be manually releasably (without tools) connected to the main body on one side and on the other side at least not manually releasably (i.e. optionally only with tools or not at all) connected to the main body. Further alternatively, it is possible that the impact shield is manually releasably connected to the main body on both sides, or connected to the main body on both sides only releasably with tools or not at all.

The impact shield comprises a restraint portion 105, which comprises a central portion 104 as well as two lateral end portions 102, 103, which, in the fastened state of the impact shield 100, preferably lie in the associated side receptacle 33a or 33b (or extend into or towards these).

FIG. 3 shows the child seat 10 according to FIGS. 1 and 2 with the impact shield 100 partially exposed so that an adjustment mechanism 101 can be seen. A first fastening element 111 can be seen, which can be fastened (for example by a screw) in an area between the side element 23 and the side bolster 32 at the side receptacle 33. A first connecting element 112 of a first connection part 110 can be fastened to the first fastening element 111 by means of guides on the first fastening element 111.

FIGS. 4 to 7 show the adjustment mechanism 101 (of the impact shield 100) in detail. The adjustment mechanism 101 comprises the first connection part 110, a second connection part 120, a guide element 130 and a locking element 140.

The first connection part 110 comprises a first drive part 113, the first connecting element 112 and the first fastening element 111. The first connection part 110 can be connected to the seat body or main body 25 in an area beside the first lateral end portion 102 of the restraint portion 105 via the first fastening element (e.g. via a screw).

The first connection part 110 may comprise a wire (in particular a metal wire, preferably a steel wire) and be connected to the fastening element 111 (in particular be fastened thereto).

The first connection part 110 can be connected to the first drive element 113 in a central portion 104 of the restraint portion 105 of the impact shield 100.

The second connection part 120 comprises, according to the embodiment, a second drive element 123, a second connecting element 122 and a second fastening element 121. The second connection part 120 can be connected to the seat body or main body 10 in an area beside the second lateral end portion 103 of the restraint portion 105 via the second fastening element 121. On this side, the fastening element 121 can be designed as a belt tongue. The belt tongue can be or become releasably locked in a suitable belt buckle in the area of the side receptacle 33b.

The second connection part 120 can be designed as a wire (in particular metal wire, preferably steel wire) and connected to the fastening element 121, in particular fastened thereto. The second connection part 120 can be connected to the second drive element 123 in a central portion 104 of the restraint portion 105.

The guide element 130 can be connected (directly) to the restraint portion 105 (in particular fixedly) in a central portion 104 of the restraint portion. The guide element 130 can be designed as a guide and comprise a guide slot 131 in which the first and second connection parts 110 and 120 can be guided.

The first and second connection parts 110, 120 can slide along the guide slot 131 (in particular along the edges of the slot) (and thus be moved from or to the lateral end portions 102, 103).

A synchronisation element 132, which can rotate about a first axis 133 and can be mounted within the guide slot 131 of the guide element 130, may be provided on the guide element 130. The synchronisation element 132 may be designed as a gear wheel or may comprise such a gear wheel.

A latch opening 134, into which the latch 142 of the locking element 140 can engage, may be provided on the guide element 130,

The first drive element 113 may comprise a first elongated hole 114 which is equipped (possibly exclusively) at its upper edge by a first toothed strip 115 with adjacent first teeth 116. At least one, preferably the lower, edge of the drive element 113 may be designed with a first recess strip 117 with adjacent first locking recesses 118. Alternatively or additionally, a (possibly further) first recess strip with (possibly further) adjacent second locking recesses may be provided on the upper edge of the drive element 113.

The second drive element 123 can have a second elongated hole 124 which (in particular in contrast to the first elongated hole) is equipped at (in particular exclusively at) its lower edge by a second toothed strip 125 with adjacent second teeth 126. A second recess strip 127 with adjacent second locking recesses 128 may be provided on at least one, preferably the lower, edge of the drive element 123. Alternatively or additionally, a (possibly further) second recess strip with (possibly further) adjacent second locking recesses may be provided on the upper edge of the drive element 123.

The first and second drive elements 113, 123 can be guided in the guide element 130 (in particular in the guide slot 131) so that they can slide in different (and in particular opposite) directions, the elongated holes 114 and 124 preferably overlapping at least in sections.

Due to the overlapping of the elongated holes 114, 124, the synchronisation element 132, which is preferably designed as a gear wheel, can engage at the top in the first toothed strip 115 and at the bottom in the second toothed strip 125 of the first and second elongated holes and interact with these, thus establishing an operative connection between them.

The drive elements 113 and 123 are arranged one behind the other in particular in such a way that their locking recesses 118 and 128 overlap at least in sections and temporarily when the drive elements slide in opposite directions. The locking element 140 is preferably mounted (below the guide element 130) rotatably about a second axis 143 such that the latch 142 can engage in the latch opening 134 of the guide element 130 and/or (in a state in which a first and second locking recess 118, 128 overlap) engage in the locking recesses 118, 128 and thus lock the drive elements 113, 123 against sliding in the guide slot 131.

Alternatively or additionally, the latch 142 and/or a further latch can engage in the above mentioned second locking recesses provided alternatively or additionally on the respective upper edge of the respective drive element 113, 123. If an additional latch is provided, it can be positively coupled to the latch 142 in such a way that it can be actuated with the latter with a single movement-or not.

In addition, an operating portion 144, which can be actuated to release the latch 142 from the clearances 118 and 128 such as to release the locking of the drive elements 113 and 123, may be provided on the locking element 140.

The locking element 140 can be spring-loaded by a spring 141, whereby the latch 142 can be forced into the locked position (and possibly can only be released by applying force to the operating portion 144).

If the operating portion 144 is actuated and it is then pulled on the impact shield 100 while the locking is open, the first drive element 113 can, in the direction of the first lateral end portion 102 in the guide slot 131, move away from the central portion 104 (and be pulled out of it at least partially). In the same way and at the same time, the second drive element 123 can also, in the direction of the second lateral end portion 103 in the guide slot 131, move away from the central portion 104 (and be pulled out of it at least partially).

Due to the preferably provided synchronisation element 132 in interaction with the toothed strips 115 and 125 (or the teeth 116 and 126) of the drive elements 113 and 123, the movements (and thus the length adjustment) are synchronous, regardless of whether it is pulled exactly in the centre of the impact shield 100 or rather on one side near a lateral end portion 102, 103. By this it is achieved that the same length change occurs on both sides, for example to prevent the impact shield from sitting less firmly (being less close to the child) on one side than on the other.

Once the user has carried out a fitting length adjustment of the impact shield 100, the operating portion 144 can be released and the latch 142 locks the two drive elements 113, 123 back together in the corresponding locking recesses 118, 128.

In FIGS. 8-13 further preferred features of the connection parts 110, 120 can be seen. In FIGS. 8 and 9, it can be seen in particular that the first connecting element 112 can be enclosed by a preferably ribbon-shaped cover 150.

In FIG. 10 it can be seen that the second connection part 120 can have a belt tongue 156.

According to FIG. 11, the second connection part 120 can also have a (ribbon-shaped) cover 151.

At least (or exclusively) the cover 150 of the first connection part 110 may have at least one channel 152 (possibly another channel 153) in which the connecting element 112 is guided at least in sections (for example, over at least 50% of its length). The channels 152, 153 may be round (circular) in cross-section. Alternatively or additionally, the cover 150 may have at least or exactly one connecting cable channel 154 in which electrical connecting cables can be guided. The connecting cable channel 154 may, for example, have an elongated cross-section (whereby a length of the cross-section may be at least 2 times or at least 5 times and/or at most 20 times as long as a width of the cross-section). The connecting cable channel 154 preferably lies between the channels 152, 153. This allows the cables 155 to be held particularly securely.

The cables 155 can be configured to supply a component of the impact shield 100 with electrical energy and/or to transmit a signal, for example to an airbag trigger mechanism.

At this point, it should be pointed out that all parts described above, considered individually and in any combination, in particular the details shown in the drawings, are claimed as essential to the invention. Modifications thereof are familiar to those skilled in the art.

Furthermore, it is pointed out that the broadest possible scope of protection is sought. In this respect, the disclosure contained in the claims may also be specified by features which are described with further features (even without these further features necessarily having to be included). It is explicitly pointed out that round brackets and the term ‘in particular’ are intended to emphasise the optional nature of features in the respective context (which does not mean, conversely, that a feature is to be regarded as mandatory in the corresponding context without such indication). The term ‘element’ should preferably denote a coherent structure which, in turn, may be connected to at least one other structure (to form a single-piece and/or non-movable overall structure) or may be delimited from all other structures.

### Reference Signs

10 child seat
20 seat area
21 seat surface
22 fastening means
23 side element
24a, 24b fastening means
25 main body
30 backrest
31 backrest surface
32 side bolsters
33a, 33b side receptacles
40 headrest
41 headrest surface
100 impact shield
101 adjustment mechanism
102, 103 lateral end portions
104 central portion
105 restraint portion
110 first connection part
111 first fastening element
112 first connecting element
113 drive element
114 first elongated hole
115 first toothed strip
116 first teeth
117 first recess strip
118 first locking recesses
120 second connection part
121 second fastening element
122 second connecting element
123 second drive element
124 second elongated hole
125 second toothed strip
126 second teeth
127 second recess strip
128 second locking recesses
130 guide element
131 guide slot
132 synchronisation element
133 first axis
134 latch opening
140 locking element
141 spring
142 latch
143 second axis
144 operating portion
150 ribbon-shaped cover
151 ribbon-shaped cover
152, 153 channel
154 connecting cable channel
155 connecting cable
156 belt tongue

1. An impact shield for a child seat, wherein the impact shield comprises:
a restraint portion,
a first connection part and a second connection part, which are each displaceable at least in sections relative to the restraint portion from at least a first position into at least a second position, and
an adjustment mechanism for adjusting the first connection part and the second connection parts from at least the first position into at least the second position, wherein the adjustment mechanism comprises an operative connection which connects the first connection part and the second connection part to one another and causes that adjustment of one of the first connection part and the second connection part causes a corresponding adjustment of the other of the first connection part and the second connection part.

2. The impact shield according to claim 1, wherein the impact shield comprises:
the restraint portion with a central portion as well as a right end portion and a left end portion,
a fixing mechanism which is configured to selectively fix or unfix the first connection part and the second connection part relative to the restraint portion, wherein the fixing mechanism comprises a latch and an engagement, wherein the fixing mechanism is provided at least in sections on a central portion of the restraint portion.

3. The impact shield according to claim 1, wherein the impact shield comprises:
a fixing mechanism which is configured to selectively fix or unfix the first connection part and the second connection part relative to the restraint portion,
wherein the first connection part and/or the second connection part comprise at least one of: at least one wire portion, at least one rope portion, at least one ribbon portion, and
wherein the first connection part and/or the second connection part has/have at least one holder for at least one electrical line.

4. The impact shield according to claim 1,
wherein the first connection part and/or the second connection part comprises at least one flexible means and/or a shear-resistant means.

5. The impact shield according to claim 4,
wherein the first connection part and/or the second connection part comprise at least one means which deforms during a respective transfer changing its curvature at least in sections, wherein the at least one means preferably corresponds to the shear-resistant means.

6. The impact shield according to claim 1,
wherein the first connection part and the second connection part move, at least in sections, in different directions during a respective transfer and/or
wherein the first connection part and/or the second connection part move, at least in sections, in a direction which deviates by less than 180° from a direction of movement of the restraint portion during the respective transfer.

7. The impact shield according to claim 1,
wherein the operative connection comprises at least one gear wheel and/or a row of teeth.

8. The impact shield according to claim 1,
wherein the first connection part is configured to be connected to the child seat in a manner that is non-releasable or is released using a tool, and/or the second connection part is configured to be connected to the child seat in a manner that is released manually.

9. The impact shield according to claim 2,
wherein the fixing mechanism forms a structural unit and/or has a common latching device for jointly locking the first connection part and the second connection part, wherein the common latching device has a common latch and/or a common clearance, which is brought into engagement with both the first connection part and the second connection part at a same time and/or is brought into engagement only with one of the first connection part and the second connection part for fixing it and a fixing of the other of the first connection part (110) and the second connection part performed by the operative connection.

10. The impact shield according to claim 1, further comprising an airbag.

11. A child seat for mounting in a motor vehicle seat includes the impact shield according to claim 1.

12. (canceled)

13. A method for adjusting the child seat, according claim 11, wherein the first connection part and the second connection part are each transferred at least in sections relative to a main body of the child seat from at least the first position into at least the second position, wherein the adjustment of the position of one of the first connection part and the second connection part causes the corresponding adjustment of the other of the first connection part and the second connection part.

14. The method according to claim 13, for adjusting the child seat, wherein the first connection part and the second connection part are fixed relative to the main body by a common action taking place centrally.
